(19) United States
(12) Patent Application Publication
(10) Pub. No.: US 2008/0073022 A1
(43) Pub. Date: Mar. 27, 2008

(54) MULTI-PIECE PVA MODELS WITH NON-BRITTLE CONNECTIONS

(75) Inventors: Gregory Hyde, Menlo Park, CA (US); Jane Sifuentes, San Jose, CA (US); Kim Hayenga, Madera, CA (US); Eric Eli, Redwood City, CA (US); Jim Phelan, Athenry (IE); Ellen Roche, Galway (IE)

Correspondence Address: WORKMAN NYDEGGER, 1000 EAGLE GATE TOWER,, 60 EAST SOUTH TEMPLE, SALT LAKE CITY, UT, 84111, US

(73) Assignee: ABBOTT LABORATORIES, Abbott Park, IL (US)

(21) Appl. No.: 11/748,378

(22) Filed: May 14, 2007

Related U.S. Application Data
(60) Provisional application No. 60/799,889, filed on May 12, 2006.
(60) Provisional application No. 60/915,871, filed on May 3, 2007.

(51) Int. Cl. B65H 69/02; C08L 23/02

(52) U.S. Cl. 156/158; 524/10; 524/13; 524/543; 525/191

(57) ABSTRACT

Models are made through a process that provides for a bonding mechanism of pre-made PVA parts to create more complex structures. The components are bonded together by wetting the surfaces to be connected with a PVA solution. The components are then adjoined together and bonded through an additional processing or curing, e.g., freeze-thaw cycle. This process can be repeated multiple times to create more complex structures or models. In another embodiment, a textile or fabric type material is used to increase the radial strength of the models. In such an embodiment, a usually thin piece of textile material, such as a nylon fabric, may be placed within the core molding. Liquid PVA then flows through the nylon hosiery or textile material and one or more curing process are then applied, which allows the PVA solution to bond or otherwise adhere with the material.

### CROSS-REFERENCE TO RELATED APPLICATIONS

This application claims domestic priority to U.S. Provisional Application No. 60/799,889 (Attorney Docket No. 17066.37) entitled “PVA MODELS AND METHODS OF MAKING SAME” filed May 13, 2006, the contents of which are incorporated herein by reference in its entirety. This application also relates to U.S. application Ser. No. ______, (Attorney Docket No. 17066.37.1) and Ser No. ______, (Attorney Docket No. 17066.37.3), entitled “FORMING VASCULAR DISEASES WITHIN ANATOMICAL MODELS” and “FORMING PRE-MADE PIECES OF PVA INTO SPECIFIC MODELS”, respectively, filed on the same day herewith, the contents of each are also incorporated herein by reference in their entirety. This application also claims priority to and the benefit of U.S. Provisional Application No. 60/915,871 entitled “SYNTHETIC MODELLING OF THE COMMON FEMORAL ARTERY AND SURROUNDING TISSUE” filed May 3, 2007 (Attorney Docket No. 17066.37.4), the contents of which are also incorporated herein by reference in its entirety.

### BACKGROUND

Being a leader in modern medicine means utilizing the most current technology to provide the best patient care. Accordingly, medical professionals strive to stay on the cutting edge of medicine through new devices, better medications, and the latest procedures. In order to learn about what's new and what works best for patients, they rely heavily on health care companies devoted to discovering new medicines, new technologies, and new ways to manage health. As such, health care companies must continually develop and test innovative medical techniques, devices, and medicines using human and mammalian specimens, cadavers, test groups, and the like.

Although actual mammalian organs are the desired mechanism for testing and discovering medical miracles, such anatomies are costly and not always easily ascertainable. Accordingly, non-organic models are widely used to demonstrate the functionality of various medical devices and techniques used in percutaneous interventional, surgical, and diagnostic procedures. Clearly, materials selected for medical modeling in research and development of medical devices should replicate tissue as closely as possible. Accordingly, the medical industry has a continual need for vascular models that are clear, flexible, and/or possess the physical characteristics of actual vessels and other anatomies.

Early anatomical models developed for medical testing used blown glass to replicate vessels and arteries. Although the translucent property of glass allows good visual inspection of the functionality of medial maneuvers, these models are not desirable due to the non-tissue like surface of the glass. Further still, there have been attempts to construct vascular models of latex, silicone, or other similar types of materials. Again, a shortcoming of these types of models is their poor ability to replicate tissue.

One material that replicates the large weight percentage of water in the human body can be a hydrous polymer (hydrogel). Historically, however, these types of materials include a serious defect in that they are inferior in mechanical strength. More recently, however, poly(vinyl alcohol) (PVA) has been used to replicate body tissues in medical development. Although there are numerous mechanisms used for preparing the PVA for tissue replication, generally molds are used to convert hot liquid PVA mixtures into the vascular models. A dehydration, freezing, thawing, or combination type process of the molded liquid PVA is then used to cure or fully solidify the hydrogel into a suitable more rigid substance for modeling. Accordingly, the final PVA product yields a material that more closely resembles human and mammal anatomies.

Although the use of PVA allows for more accurate modeling of tissue, there are still several shortcomings and deficiencies in using cured, modeled PVA for representing a vessel or tissue. For example, it is often difficult to produce a complex organ using a single mold. Accordingly, several molds are used for pre-processing or creating various parts, which are then glued or otherwise connected together to form the desired organ. Current mechanisms for attaching the various vessels, arteries, and other tissues together, however, produce brittle, loose connections. As such, the junction between the molded pieces breaks and/or otherwise leaks when performing the desired medical testing or procedure. Accordingly, the overall organ developed again does not accurately represent the actual anatomy.

Another shortcoming of current PVA modeling is the representation of lesions or other defects within an organ. Often, it is desirable to see how medical functions and devices perform with the presence of abnormalities within the body; and therefore, the organ model needs to include these defects. Current mechanism for creating and modeling lesions and other vascular diseases, however, do not accurately represent the blemish composition or consistency.

For example, when forming a PVA organ, a “lost-wax” process is typically used similar to that for making jewelry, bronze sculptures, and other molded items. As such, in order to form the abnormality, portions of the wax or other core material are modified to form the lesions directly in a metallic or similar mold. For instance, often a wire is placed between two pieces of wax core, which is offset from the inner walls within the casting. As the hot liquid PVA flows into the mold, the void created by the attached wire provides for a buildup of PVA in that particular area, which represents the lesion. After curing the hot PVA in the mold, the wax core is dissolved and the wire removed leaving the desired organism with the blemish formed within the void created. There are, however, numerous types of lesions with various shapes, densities, and other properties other than those formed by the above mechanism and PVA material. As such, the lesions developed by this process again do not accurately represent the diseased vessel or artery within bodily tissue.

Another deficiency or drawback of current PVA modeling systems is the inability to modify a PVA modeled organ once fully formed. Often times, however, it is desirable to form or fit a particular vessel or tissue to that of an actual individual. In order to properly create such individualized organs, separate molds for each organ must be independently made, which causes an increase in expense and development time. In a similar situation, different organs within the overall body may be substantially similar in some respects (e.g., generally cylindrical in shape); however, due to other changes in form (e.g., the manner in which an organ fits in the body) they require separate molds. Again, this increases the expense and time of producing different anatomy types as well as additional overhead in maintaining a plurality of varying molds.

### BRIEF SUMMARY

The above-identified deficiencies and drawback of current anatomical modeling systems are overcome through example embodiments of the present invention. For example, embodiments described herein provide: (i) tight, non-brittle connections of PVA pieces in order to constructively form simulated complex anatomical models; (ii) anatomical models with increased radial strength to represent muscle or other simulated tissues; (iii) anatomical models with simulated vascular diseases that more accurately replicate such abnormalities therein; and (iv) mechanisms for creating multiple different anatomical models using partially processed, preformed pieces of PVA.

As mentioned above, one example embodiment described herein provides for tight, non-brittle connections of PVA, which are joined to constructively form simulated complex anatomical models that can be used for demonstrating, testing, and/or developing medical functions and/or devices. In this embodiment, ends of preformed PVA material (i.e., a single or multiple pieces) can be bonded together by wetting the two surfaces to be joined with a liquid PVA solution. The preformed PVA material will typically only be partially processed, thus allowing for increased cross-linking between surfaces. The surfaces are also closely adjoined together using molds, fixtures, or other similar devices. The pieces or ends of PVA are then bonded by performing a curing process (e.g., a freeze-thaw cycle) on the liquid PVA solution, which provides a cross-linking between the liquid PVA solution and the adjoined components to form a tight, non-brittle connection. This process of boding preformed PVA parts can be repeated multiple times to create more complex structures.

In accordance with another example embodiment, an anatomical model with an increased radial strength is provided, which represents muscle or other similar tissues. In this embodiment, a textile type material is provided, which is sufficiently porous to allow the liquid PVA solution to flow therein. The textile or cloth like material can be placed into a mold and/or optionally combined with an already preformed piece of PVA, which can be only partially processed. If the fabric is to be combined with an already preformed piece of PVA, the surfaces of the two pieces of material should be adjoined together in a similar manner as that described above with molds, fixtures, or other similar devices. Liquid PVA solution may then be injected into or otherwise applied to the fabric type material and solidified therein through a curing process (e.g., freeze-thaw cycle). The result is a model that replicates specific anatomies present in a human and/or mammal bodies and provides radial strength greater than just the cured PVA solution alone.

The above processes can be combined with other embodiments described herein and in various manners to also provide for more complex anatomical models. For example, one or more of specific models formed from pre-molded pieces of partially processed PVA may be joined using a bonding process described above. Further, the textile type material may also be added to the preformed, partially processed portion of PVA before, during, or after bonding. Of course, other combination of process are also recognized and contemplated herein.

In another embodiment, the above can be applied in layers to provide a common femoral artery model with a synthetic polymer that will display both strength and flexibility and that is used in the artery, muscle, and subcutaneous tissue. The artery can be a combination of polyvinyl-alcohol (PVA or PVOH), fabric, and cyanoacrylate adhesive, where PVA contributes to the compliance component, fabric adds structural support, and the adhesive may be used to simulate calcification. The muscle can be composed of PVA and the subcutaneous tissue can be a mixture of PVA and glue plus water as described below.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantageous features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates various preformed pieces of PVA that can be joined in accordance with the example embodiments to provide an anatomical model as described herein;

FIG. 1B illustrates the joining and/or bonding of the pieces of PVA to form tight, non-brittle connections in accordance with example embodiments;

FIG. 1C illustrates an example mechanism for bonding the ends of a two-dimensional piece of PVA to produce a three-dimensional structure in accordance with example embodiments;

FIG. 2A illustrates an example of using a cavity mold to form a preprocessed vascular disease within an anatomical model in accordance with example embodiments;

FIG. 2B illustrates an example of the cavity mold with the vascular disease included therein in accordance with example embodiments;

FIG. 2C illustrates various vascular diseases that can be separately formed using various materials in accordance with example embodiments;

FIG. 3A illustrates the transformation of a preformed, partially cured piece of PVA into a more specific anatomical model in accordance with example embodiments;

FIG. 3B illustrates an example mold that can be used to mass produce pieces of PVA, which can later be formed into more specific anatomical models in accordance with example embodiments described herein;

FIG. 4 illustrates a flow diagram of a method of joining pieces of PVA in order to constructively form simulated complex anatomical models in accordance with example embodiments;

FIG. 5 illustrates a flow diagram of a method of creating an anatomical model with increased radial strength to represent muscle or other similar tissues in accordance with example embodiments;

FIG. 6 illustrates a flow diagram of a method of creating a PVA anatomical model with simulated vascular disease that more accurately replicates such abnormalities in accordance with example embodiments;

FIG. 7 illustrates a flow diagram of a method of creating multiple different anatomical models by forming a preformed, partially processed piece of PVA into a desired specific shape in accordance with example embodiments;

FIG. 8 illustrates a flow diagram of a method of manufacturing pieces of PVA using a common or standard mold in accordance with example embodiments

FIG. 9A illustrates an anatomical representation of a common femoral artery displaying bifurcation;

FIG. 9B illustrates a femoral artery core developed in accordance with example embodiments;

FIG. 9C illustrates a artery core within a mold for applying bone, muscle, and subcutaneous tissue to the femoral model in accordance with example embodiments;

FIG. 9D illustrates a complete femoral model build at a cross-sectional view in accordance with example embodiments; and

FIG. 9E illustrates a mold for forming the outer diameter of the femoral artery in accordance with example embodiments.

### DETAILED DESCRIPTION

The present invention extends to methods and systems that provide one or more of the following: (i) tight, non-brittle connections of PVA pieces in order to constructively form simulated complex anatomical models; (ii) anatomical models with increased radial strength; (iii) anatomical models with simulated vascular diseases that more accurately replicate such abnormalities therein; and (iv) mechanisms for creating multiple different anatomical models using partially processed, pre-shaped pieces of PVA.

Prior to discussing embodiments in great detail, it will be beneficial to define terms that will be used consistently herein. First, the term “liquid PVA” or “PVA solution” refers to poly(vinyl alcohol) mixture in its liquid form. The PVA may be heated somewhere between 50-150° C. and comprises some form of PVA, water, dimethylsulfoxide (DMSO) mixture; however, other well known temperatures and mixtures of PVA solution may be implied herein. For example, the PVA solution may be in a gel form at room temperature and/or may not include any other materials other than PVA.

Further, the terms “preformed”, “pre-made”, “pre-molded,” or “pre-shaped” PVA refers to pieces or components of PVA that have been at least partially formed and at least partially processed into a specific shape. As will be appreciated, the PVA components can be any of a wide variety of shapes including flat sheets, three dimensional simple objects, and/or replicas of entire vascular structures including hearts, half hearts, tubes, replicas of vessels, tissues, or other similar structures. The individual components can be made through any well known PVA modeling process; however, the individual components will typically be only partially cured.

The terms “partially processed” or “partially cured” PVA refers to pieces of PVA in any shape that still have processing potential. For example, the partially processed pieces of PVA are only partially cured through one or more freeze-thaw cycle using crushed dry ice, slurry dry ice, alcohol, environmental chamber, or any other well known mechanism of freezing-thawing or dehydration of PVA to form a desired shape. Typically, the PVA will be processed less than four times, and may be only a single freeze-thaw cycle or other form of processing. In any event, the partially cured PVA material should remain malleable and have cross-linking potential for bonding and other purposes described herein.

As mentioned previously, current mechanisms for connecting preformed, pre-made, or pre-molded pieces of PVA do not provide tight, non-brittle connections. Instead, anatomical models are physically constructed through interlocking type fittings or by gluing pieces of PVA together. Accordingly, in an initial embodiment, anatomical models are made through a process that provides for a bonding mechanism of pre-made PVA parts to create complex anatomical structures. As previously mentioned, the PVA components can be any of a wide variety of shapes including flat sheets, three dimensional objects, and replicas of entire vascular structures including hearts, half hearts, tubes, replicas of vessels, tissues, or other similar structures. Nevertheless, the individual components will typically be only partially cured.

The components can then be bonded together by wetting the surfaces to be connected with a PVA solution. Regardless of the type of liquid PVA solution used to wet the surfaces (e.g., heated, mixture type, gel form, etc.), the components are then held or adjoined together using molds or other fixtures. The term “adjoined” as used herein does not necessarily require that the connection ends are touching; however, they can. Instead, adjoined means that the ends are in close enough proximity to allow the PVA solution to join or reside simultaneously on the ends. Nevertheless, lumens or other areas of the PVA components can be kept firm and/or unobstructed. The components can then be bonded through the additional use of processing or curing, e.g., freeze-thaw cycle as described above. By combining and bonding the other combinations of components, more complex models can be used for testing and/or demonstrating medical devices and/or functions.

This process can be repeated multiple times to create more complex structures of models. Examples may include: complete peripheral vascular models made from straight tubes of discrete inner diameters; molded bifurcation path bonded to a bowel like compression of a heart; molded coronary arteries bounded to the outer surface of a 3D PVA molded hollow heart; or any other vascular model. Further, by bonding tubes or vessels in such mechanism described above, tight, non-brittle connections can be established to allow a model or vessel to move semi-freely from the support in response to a device inside a modeled PVA vessel. In other words, such bonding mechanism while providing a more complex model still provides a connection that more closely resembles the actual anatomy of the human body or mammalian organs than those of typical connectors and/or glues.

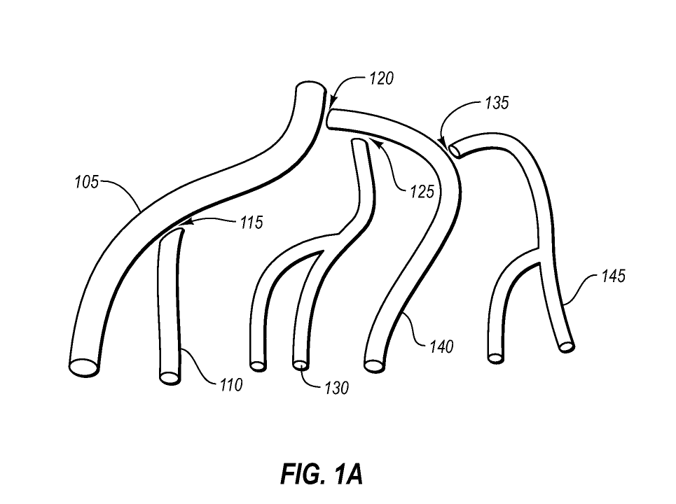

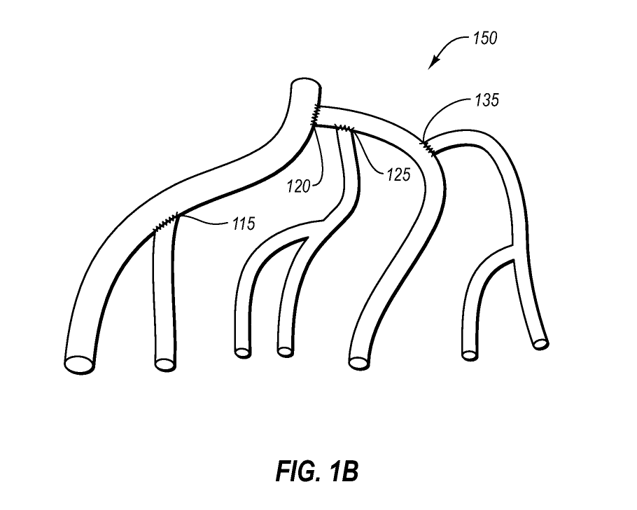

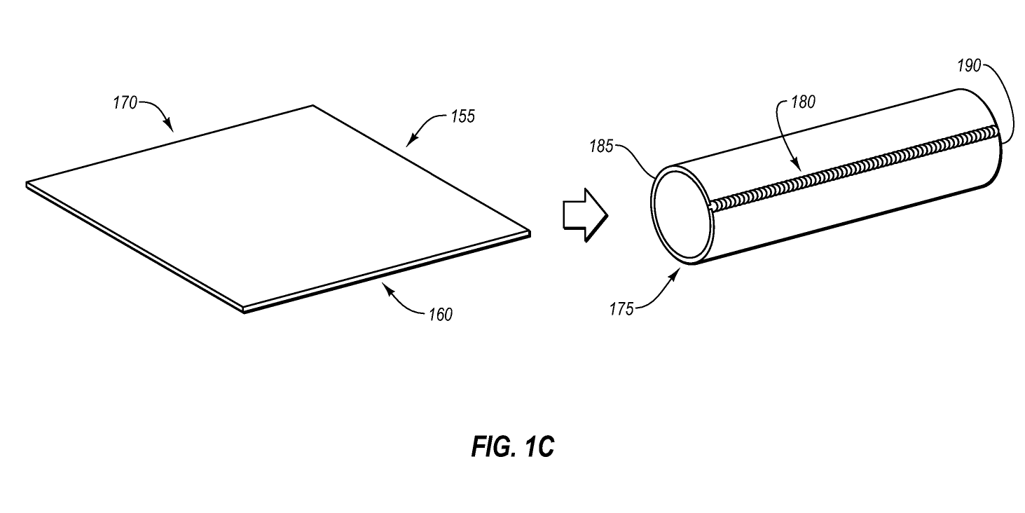

FIG. 1A illustrates an example of a vascular model formed using the above described exemplary embodiments. As shown, the vascular model can be made of several various PVA pieces 105, 110, 130, 140, 145. Each of the pieces will be bonded together in either a single or multi-process manner, but typically the components 105, 110, 130, 140, 145 are only partially processed, i.e., they still have cross-linking potential. For example, each piece of PVA material 105, 110, 130, 140, 145 may be pre-processed through a single freeze-thaw or dehydration cycle as is well known in the industry. Ends of the various pieces for example ends 115, 120, 125, 135 as shown in FIG. 1A may then be held together or at close proximity using such things as molds or other fixtures. The components are then bonded together by wetting the surfaces to be bonded 115, 120, 125, 135 with a PVA solution, and then completing the process through a series of one or more freeze-thaw cycles and/or dehydration similar to those mentioned above (e.g., using crushed dry ice, a slurry of dry ice and alcohol, environmental chamber, pressure chamber, or the like).

FIG. 1B illustrates the completed vascular model 150 with each PVA component 105, 110, 130, 140, 145 securely bonded together at the various joints, 115, 120, 125, 135 to produce tight, non-brittle connections after the above mentioned curing process. In other words, by performing the additional curing, a cross-linking now occurs between the ends that were adjoined and where the liquid PVA solution was applied.

Although the three-dimensional (3D) pieces 105, 110, 130, 140, 145 above can be used to create a more complex model 150 using the joining mechanism described herein, two-dimensional (2D) or single pieces of PVA can be used to make more complex shapes using a similar process. For example, FIG. 1C illustrates a flat piece of PVA 155 where the ends 160 and 170 can be joined 180 to create a 3D tube 175. Similar to above, the 2D flat piece of PVA 155 can be partially cured, which allows it to be shaped using a mold or other fixture and the two ends 160, 170 can be brought together 180 as shown. Liquid PVA solution can then be applied to the ends 160, 170 (either before of after adjoining the ends 160, 180 together) in a manner similar as that described above. A curing process can then be performed to create a tight, non-brittle connection 180 between the two ends 160, 170 when forming the tube 175.

Further, although the above created tube 175 can be a simplistic formation of a 3D model, more complex models are capable of being developed. For example, two halves of a complex vascular model (such as a heart) may be bonded or joined using a similar process as described above. In addition, partial processing and/or partial bonding may be performed as desired. For example, in the above bonding mechanism shown in FIG. 1C, only a partial curing process may be performed after applying the liquid PVA and/or the curing process may be performed on only a portion of the tube 175. Further, by only doing a partial curing (e.g., a single freeze-thaw cycle), the tube or other formed structure may be further modified in accordance with embodiments described in greater detail below. In addition, the partially processed new shape may now be combined with other pieces of partially cured, preformed PVA (or even the joining of ends 185, 190) to again form more complex structures and this process may be repeated multiple times as necessary. In other words, a minimal amount of processing can be performed to these pieces in order to attach them with the liquid PVA solution since they still have some processing potential. This allows actual bonds to be made that are durable, tight, and more accurately represent the human or mammalian vascular anatomy. Further, with additional curing processes, a more secure cross-linking may be done to the connected ends to produce the desired anatomical model.

As previously mentioned, current human and mammalian models provide representations of some disease states; however, the base material of the model is typically used to create them. More specifically, diseased arterial models are often produced by reducing the lumen diameter through a thickening of the vessel wall with silicon or other type materials. Such mechanisms for producing vascular diseases within arterial models; however, do not accurately represent the material of such vascular deformation. Accordingly, other embodiments provide vascular diseases that are created separately from the molding process of the artery itself. As such, the material used to make the disease duplicates and/or more accurately simulates the physical properties of the human or animal disease. For example, the materials can provide mechanisms for creating models of fibrous plaque, friable plaque, fatty plaque, calcified lesions, or any combination or other similar types of deformation.

The terms “lesions”, “chronic total occlusion”, “contusion”, “plaque”, “vascular diseases”, and the like are used herein interchangeably, and are meant to convey any abnormality or disease state found in human or mammalian bodies. Also, there may be any number of materials that can be used to produce various types of simulated plaque or other vascular diseases combined with different anatomies. Examples of such materials used that produce plaques that occur in human arterial diseases are presented in Table 1. As will be appreciated, however, other materials

TABLE 1

| | | | Simulated |
|---|---|---|---|
| | | | Plaque |
| | | | Produced After |
| Material 1 | Material 2 | Material 3 | Processing |
| Polyvinyl | PVA | | Fatty Plaque |
| Acetate-Based | | | |
| Glue (e.g., | | | |
| Elmer's ® Glue) | | | |
| Polyvinyl | Sodium Borate | PVA | Chronic Total |
| Acetate-Based | | | Occlusion |
| Glue | | | |
| PVA | | | Restenosis |
| Long Chain | PVA | | Fibrous Plaque |
| and/or Cross- | | | |
| Linked Polymer | | | |
| of Fiber or | | | |
| Fabric | | | |
| Sodium Borate | PVA | | Friable Plaque |
| Cyanoacrylate | PVA | | Calcified Plaque |
| Adhesive | | | |

similar or dissimilar to those above may be used to produce these various types of disease states. Further, water will typically be a solvent component in one or more of the above simulated plaque materials.

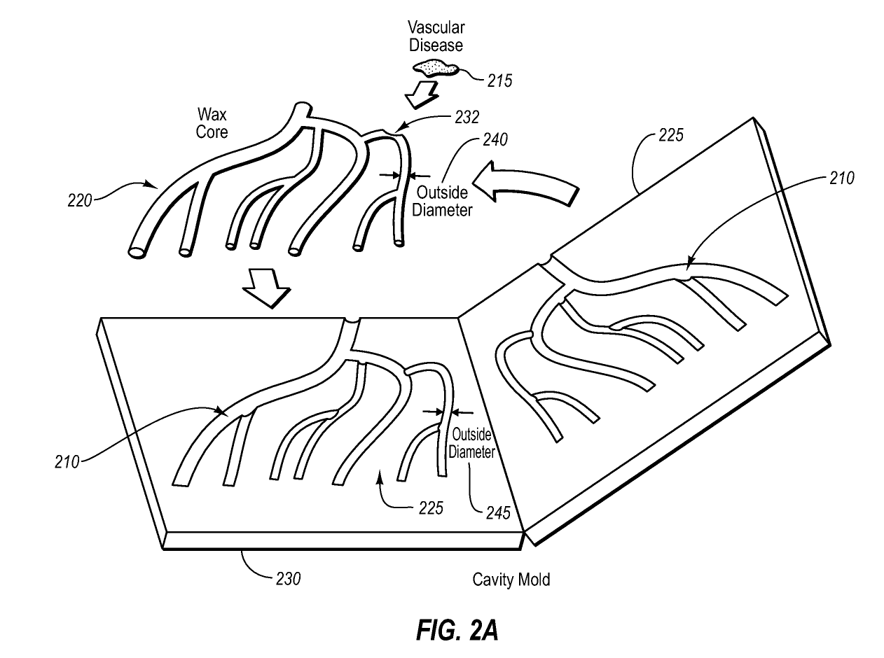

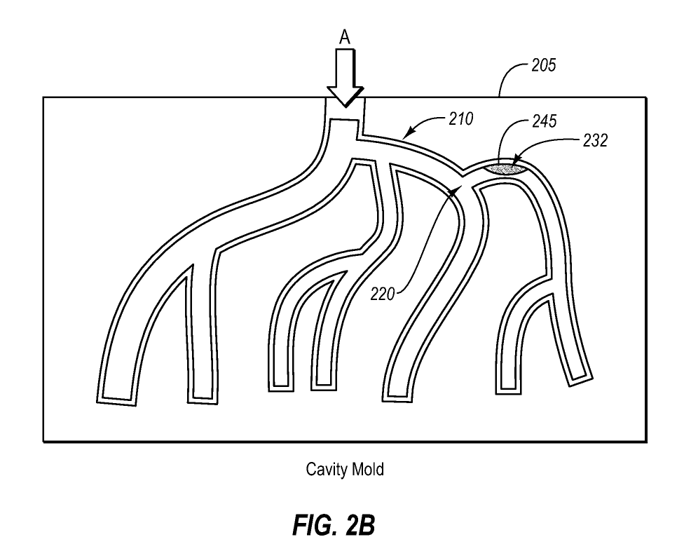

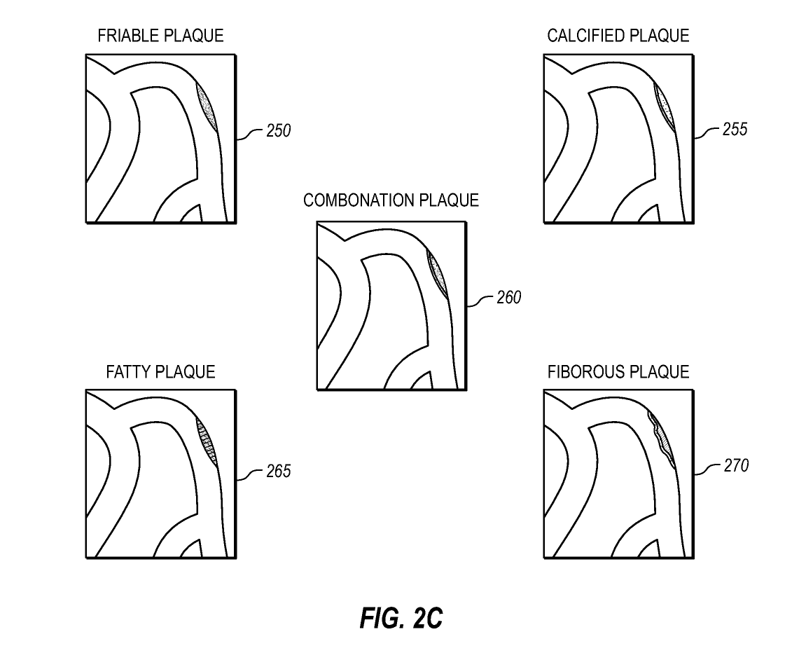

Once the lesion has been created or at least partially produced, the disease may then be combined with an anatomical model in a number of ways. For example, as shown in FIG. 2A, the vascular disease 215 may be placed directly into a cavity mold 210 during the processing of creating the arterial model. More specifically, wax cores 220 similar to the one shown in FIG. 2A can be molded using a core mold (not shown) without lesions. Lesions or vascular diseases 215 can then be added post casting by removing a portion of the wax at the appropriate locations on the wax core 220, shown for example as void 232 of the wax core 220.

As will be appreciated, if many replications of lesion 215 are needed then the voids similar to void 232 can be fabricated into the core mold used to create the wax core 220 in the appropriate locations. On the other hand, if only a few lesions 215 are needed, then a soft material such as an enamel paint, polish, silicone, or urethane can be added to the mold in the appropriate locations to create a void in the produced wax core 220. Of course, any number of mechanisms including carving, use of other chemical processes, or other molding techniques can be used to create such voids 232 in the wax core 220.

The vascular disease 215 can then be placed within void 232 of the wax core 220 and two pieces 225, 230 of core mold 210 can then be brought together with the wax core 220 and the lesion material 215 included therein. Because the outer diameter 240 of the wax core 220 is smaller than the outer diameter 245 of the core mold 210, an offset or gap is formed. As such, when liquid PVA flows into the core mold 210, a lumen lining is created between the wax core 220 and the offset created from the core mold 210.

As will be appreciated, various materials or combinations of materials can be added to the enlarged space between the wax core 220 and the cavity mold 210 to produce simulated lesions 215 of various physical characteristics. FIG. 2B shows the core model 210 with both the wax core 220 and the vascular disease 215 in the void 232 created. Liquid PVA or other similar solution can then be placed into the opening of the core model 210, as indicated by arrow A, and the appropriate curing process can then be provided to create the anatomical model with the simulated plaque, lesion, chronic total occlusion or other various vascular diseases. In other words, the lesion material can be placed between the wax core 220 and the cavity mold 210 before the mold is closed. The cavity mold 210 can then be closed and the mold 210 filled with the vessel material, which can then be at least partially processed to form the vessel model with the abnormality therein.

In another embodiment of the present invention, however, the lesion material 215 may be formed separately and added to a preformed PVA component any time during or after the formation of the anatomical model. For example, the vessel material (i.e., the PVA that forms the model) may be partially cured and the vascular disease 215 created in a different process as described herein. The lesion may then be coated with liquid PVA solution and placed in the desired location within the anatomical model. A curing process may then be performed to bond or cross-link the vascular disease 215 to the desired region of the vascular model.

In yet another embodiment, the vascular disease 215 bonds to the liquid PVA by first covering the pre-made vascular disease with liquid PVA solution prior inserting it 215 into the mold 230. That is, the vascular disease 215 formed within the core mold 210 and void 232 created may also be coated with liquid PVA and one or more curing cycles are then performed thereon. The partially processed PVA coated vascular disease can be then placed in the core mold 230 as described above. During the injection process of the liquid PVA solution into the opening of the enclosed mold 210, the liquid PVA bonds with the partially process PVA coated vascular disease placed within the void 232. This ensures, among other things, that as the liquid PVA is injected into the mold 210, the vascular disease 215 does not move downstream from the desired placement of the disease in the void 232.

There may be many processes for separately making the various types of plaques or lesions 215 using the materials noted above. For example, the process for the fatty plaque lesion material (shown as 265 in FIG. 2C) may be to first combine a polyvinyl acetate-based glue (e.g., Elmer's® Glue) with the PVA solution and performing one or more freeze-thaw cycle or other curing processes. By increasing the number of curing cycles, a firmer contusion or disease can be produced. Also, increasing the ratio of glue to PVA solution produces a more gelatinous material. Similarly, increasing the amount of PVA in the liquid solution (e.g., PVA, DMSO, and water) produces a firmer material, while decreasing the amount of the PVA in the liquid solution produces a more gelatinous material.

When making a restenosis, liquid PVA solution may be mixed with water, DMSO, or other similar solutions. By decreasing the amount of PVA in the solution, the firmness of the material is reduced and increasing the amount of PVA increases the firmness of the processed material.

The mechanism for making fibrous plaque lesion material (shown as 270 in FIG. 2C) may be performed by taking a long chain and/or cross-linked polymer, fiber, and/or fabric and placing it in the space in the cavity mold, between the cavity mold wall and the wax core. The cavity core may then be filled with liquid PVA solution followed by one or more curing cycles. In an alternative embodiment, long chain and/or cross linked polymer, fiber, and/or fabric material can be mixed into the hot solution of PVA. This resulting material is placed or injected into the cavity mold between the wax core and the cavity mold followed by a freeze-thaw or other curing process. Alternatively, the solution of PVA can be placed in the cavity mold and a long chain polymer or cross linked polymer of fiber or fabric material can be laid on or pressed into the solution followed by a curing process. Of course, the lesion may also be applied to a partially cured arterial model as also described above.

Friable plaque lesion material (shown as 250 in FIG. 2C) may be produced by pouring portions of borax into water and allowed to settle. The excess water may then be poured into the PVA solution and stirred. Increasing the ratio of wet borax to solution of PVA increases the friable characteristics of the friable plaque lesion material 250. Similar to above, the resulting friable plaque lesion material 250 can be placed or injected into the cavity mold between the wax core and the cavity mold followed by a curing process, or can be applied or bonded to a preformed piece of PVA as described above.

Calcified plaque lesion material (shown as 255 in FIG. 2C) may be processed by taking cyanoacrylate adhesive and placing it on the surface of a pool of water and allowing the water to evaporate. The dried, hard cyanoacrylate adhesive left after the water has evaporated can be used whole or broken into pieces and can be mixed into the solution of PVA. Alternatively, the cyanoacrylate adhesive can be placed on the surface of a pool of water and a rod can be placed into the pool of water. The cyanoacrylate adhesive can be collected on the rod and then dried. The dried cyanoacrylate adhesive can be removed from the rod and mixed into the PVA solution, which can then be placed or injected into the cavity mold and the appropriate freeze-thaw cycling process performed as previously described. Alternatively, fiber and/or processed, optionally clear, PVA can be coated with the cyanoacrylate adhesive. The cyanoacrylate adhesive may then be allowed to dry or cured by an accelerant. Of course, other adhesives that produce a rigid or crystalline final product could be used and placed in the cyanoacrylate adhesive.

The de-ionized water soak and the PVA process causes a change in the cyanoacrylate adhesive making it go from semi clear to white. This also changes the crystalline of the cyanoacrylate adhesive. Nevertheless, in the described methods of making calcified plaque lesion material, the exposure of the cyanoacrylate adhesive to de-ionized water produces a material that replicates calcification found in the human arteries. Similar to above, the resulting calcified lesion material can be placed or injected into the cavity mold between the wax core and the cavity mold followed by a curing process, or can be applied or bonded to a preformed piece of PVA as described above.

There may be numerous materials and processes for producing various types of lesions or other vascular diseases than those noted herein. For example, as shown in FIG. 2C, two or more of the above-identified lesions may be formed to produce a combination plaque disease 260. Accordingly, the particular lesion or disease created as well as the materials used to create them are used herein for illustrative purposes only and are not meant to limit or otherwise narrow the scope of the present invention unless otherwise explicitly claimed.

In another exemplary embodiment, a textile or fabric type material can be used to increase the radial strength of anatomical models. In such an embodiment, an optionally thin piece of textile material, such as a nylon fabric, may be placed within the core molding. For example, the textile type material may be placed over the wax core before injection of the PVA solution into the core mold. The PVA then flows through the nylon hosiery or textile material and one or more curing process are then applied, which allows the PVA solution to bond or otherwise adhere with the material.

Alternatively, and in a similar manner as the bonding of two pieces of PVA components described above, a partially processed piece of PVA and the textile or cloth type material can be adjoined together. Liquid PVA solution can then be applied to the material, such that the liquid PVA flows through the textile material and comes into contact with the partially processed piece of PVA component. The liquid PVA solution can be applied to the textile material and/or the partially processed PVA component. One or more curing processes can then be performed as previously described in order to bond or cross-link the liquid PVA to the partially processed piece. Of course, other combinations of bonding or solidifying the liquid PVA with the textile type of material may also apply. As such, the above examples of how the liquid PVA solution is solidified and applied to the textile type material is used herein for illustrative purposes only and is not meant to limit or otherwise narrow the scope of embodiments describe herein unless otherwise explicitly claimed.

Any type of textile material may be used. The only condition is that the material should be porous enough to allow the PVA to flow within the material and solidify therein during the curing process. Moreover, either a small or entire portion of the anatomical model may be covered in the textile material, which then increases the radial strength to allow for such things as PVA vessel model that can withstand fluid pressure.

As previously mentioned, another deficiency or drawback of current PVA modeling systems is the inability to modify a model once fully formed. Further, in order to properly create individualized organs, separate molds for each organ must be independently made, which causes an increase in expense and development time. Accordingly, other example embodiments overcome these deficiencies by providing partially cured, preformed pieces of PVA that are capable of later being formed into more specific anatomical models.

In this embodiment the partially cured, pre-made pieces of PVA can take on many forms and shapes and are often referred to herein as “common” or “general” shaped pieces of PVA. For example, the common shape may be a flat, tubular, cone, spherical, or other similar shape. In fact, more complex shapes such as full organs are also contemplated herein. Nevertheless, such pre-molded components are considered common or general shaped in that the particular shape can be produced using standard or common molds, and then later formed into a more specific or desired shape. As such, the preformed pieces of PVA are only partially cured or cross-linked such that they can later be formed into the more specific anatomical models that then have additional processing (e.g., freeze-thaw cycle) to retain the new shape.

For example, FIG. 3A shows a preformed piece of PVA 305. This straight piece of PVA tubing 305 is only partially processed by, e.g., a single freeze-thaw cycle. The general shape piece of PVA 305 can then be shaped internally or externally as desired. For example, a malleable rod, wire, or shaft 310 can be formed into a desired shape within the piece of PVA 305 as shown. Note that often times it is beneficial to cover the malleable object 310 with a flexible polymer or other type of tube to prevent collapsing or kinking of the tubing when it is bent by the malleable object 310. Additional curing cycles can then be performed on the newly shaped tubular piece of PVA 315 such that it maintains the desired shape that replicates a specific anatomy.

Although a bent wire 310 can be used to form the incomplete processed straight PVA tubing 305 into the desired shape 315, other malleable objects 310 may also be used. Further, although the malleable object 310 can be placed on the interior of the tube 305 (representing the lumens of an organ), exterior items or forms can also be used to shape the partially cured piece of PVA. In fact, many other types of molding can be used to form the common shaped piece of PVA into a desired shape before performing additional curing. For example, the partially processed, preformed piece of PVA may be flat piece that is then placed into a mold used to form more complex organs, such as a heart. The partially processed flat piece of PVA may then be firmly pressed into the mold to take on the desired shape, and additional curing cycles performed as needed.

In any event, the common or generally shaped piece of PVA can be mass produced using a mold, a plate of which is illustrated in FIG. 3B. Core pins (not shown) can be placed in the center of the molds 305 with latex tubing 345 appropriately selected to represent the outer diameter of the generally shaped pieces of PVA. An additional portion or plate of the molding (not shown) having a mirror image to plate 330 can then be placed over the plate 330 and secured into place. Liquid PVA can then be injected into the injection holes 335 and the freeze-thaw or curing process then performed. Cross sectional slices of the tubes may then be made to a select portion and/or number of tubes in order to check for consistency of the PVA lining and also for endurance and other testing.

Although the above molding and use of general shaped partially cured pieces of PVA are in tubular form, as previously mentioned other shapes and other standard molds for producing these anatomical models are also contemplated. Nevertheless, by using the standard shaped forms, the number of molds needed or used can be reduced, while many specific shapes and anatomies can be created. In other words, the above process allows for multiple anatomies to be formed from a minimal number of molds.

Further, although the above molding was used to mass produce general shaped pieced of PVA, other molding is also contemplated herein. For example, the partially processed, pre-made piece of PVA may be in the form of the anatomy of a first patient. This anatomical model of the first patient may then be formed using malleable or other objects to replicate the anatomy of a second patient, wherein additional curing can be provided. This advantageously allows the use of an anatomy from one patient to be changed to an anatomy to resemble that of the second patient. As such, the use of the above shapes and mechanisms for mass producing partially processed, preformed piece of PVA are used herein for illustrative purposes only and are not meant to limit or otherwise narrow embodiments described herein unless otherwise explicitly claimed.

In yet another embodiment, any of the above procedures can be combined in any number of ways to form anatomical models used for demonstrating and/or testing medical devices and/or functions. For example, the partially cured, pre-made tube 305 may be bonded to another partially cured, preformed piece of PVA to form a tight, non-brittle connection using the bonding mechanism discussed above. These newly bonded pieces of PVA may then, or in conjunction, have a separately formed vascular disease 215 adhered thereto, have a textile type material applied to represent muscle or other tissue, and/or be reshaped into another specific anatomical model in accordance with other embodiments described above. Of course, any combination and number of repeated process can be performed on either a portion or an entire anatomical model as needed. As such, the above combination is used herein for illustrative purposes only and is not meant to limit or otherwise narrow the scope of the present invention unless otherwise explicitly claimed.

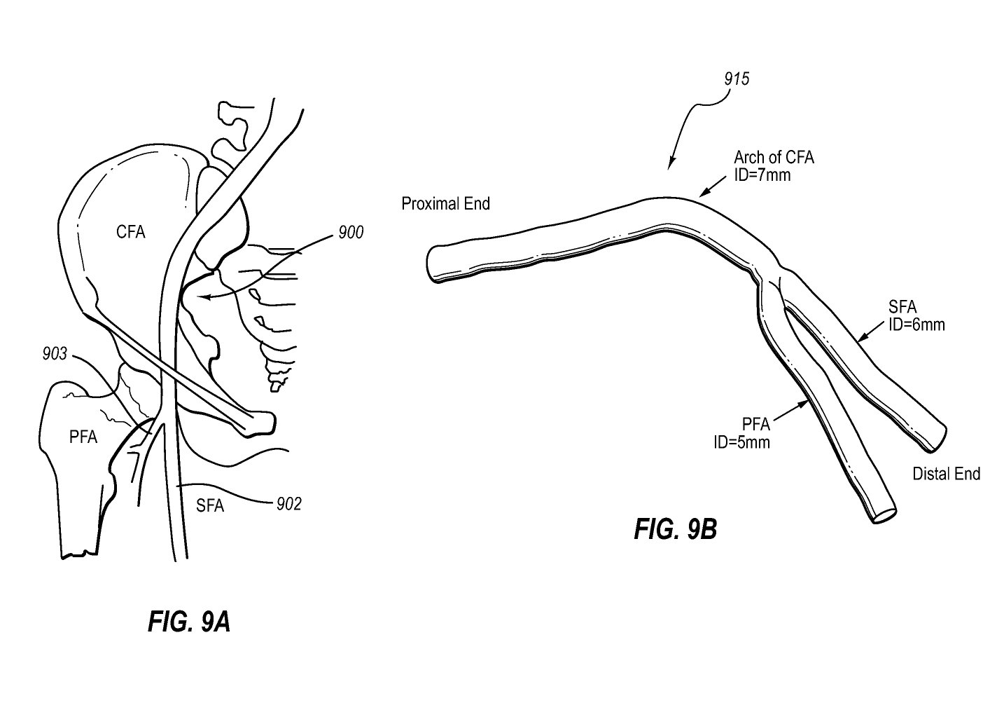

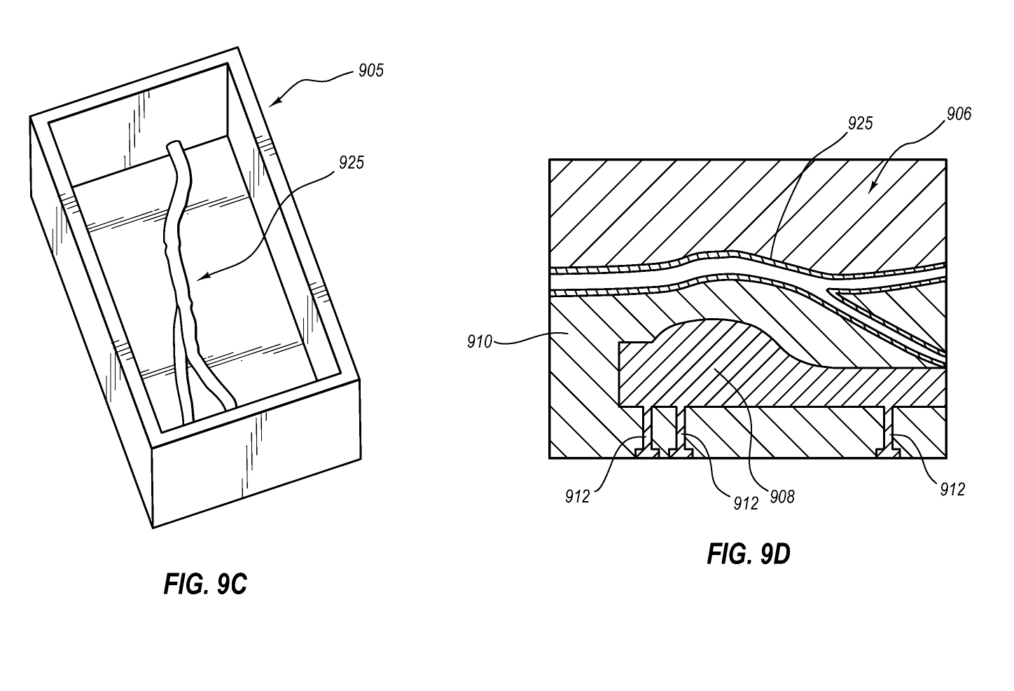

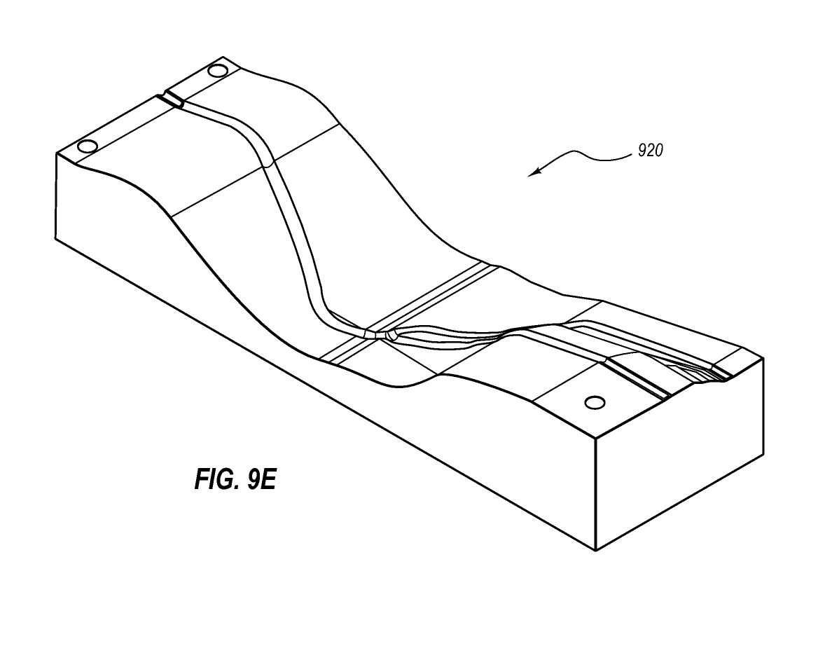

For example, one embodiment allows for the layering of the different process described above in any combination to produce more complex anatomical models. The following provides a specific example of how such layering using the above embodiments and other advantageous features described herein can provide a model of the common femoral arterial (shown in FIG. 9A) (CFA) 900 with surrounding tissues and bone. Although this specific embodiment applies to the CFA 900, as one would recognize similar process can be used to model other vascular areas in human or mammalian bodies.

The full modeling of the CFA 900 and surrounding organs is complex and composed of different proteins that make up collagen, elastin, muscle, and subcutaneous tissue. For more consistent medical testing embodiments provide a model that does not necessarily display significant non-homogeneous and anisotropic features, which may be functional for more consistent testing. Nevertheless, the model will typically show specific anatomy used in clinical procedures for access to the common femoral artery. Further, the model can include the common femoral artery (CFA) 900 and its bifurcation into the deep (PFA) 903 and superficial femoral artery (SFA) 902.

The tissue starting with the more exterior surface to the inner portions of the body and its underlying structures that aid in support comprise: the subcutaneous tissue; artery; muscle; and bone. The following describes example processes, materials, and devices used to create each of these varying anatomical structures. Although specific reference may be made to steps in the process, as will be recognized one or more of the steps may be omitted and the ordering thereof may be changed. In addition, although specific reference may be made to one or more materials or devices used in the process, one will recognize that variance in the materials and/or devices used is also contemplated herein. As such, the any specific reference to the process, material, and/or devices in creating the CFA 900 model is used herein for illustrative purposes only and is not meant to limit or otherwise narrow the embodiments described herein unless otherwise explicitly claimed.

First, the modeling of the femoral artery 900 will be discussed, since it typically has the most interaction with medial devices. The common femoral artery (CFA) 900 lies above the hip joint and muscle that are described below. The CFA 900 is derived from the iliac artery and then branches into the superficial 902 and deep artery 903 as seen in FIG. 9B. As mentioned above, the model can include the common femoral (CAF) 900, deep (PFA) 903, and superficial artery (SFA) 902 that all vary in diameter in increments of approximately 1 mm and in the order of CFA>SFA>PFA. Further, these arteries can range from 7 to 5 mm inner diameter and 9 to 7 mm outer diameter—depending of course on a myriad of factors including age, sex, disease state, etc.

The artery 900 is composed of three layers, the tunica intima, media, and externia (adventitia). Each layer is composed of differing protein structures and thicknesses that contribute to its diverse attributes. The tunica intima is the inner most layer of the artery 900, which provides the protective layer that works directly with the constant blood flow and oxygen diffusion in order to keep the body alive. One parameter that the model can replicate is the tunica intima's lubricity, which is important due to the device/surface interaction.

The layer surrounding the tunica intima is the media layer. The function of this layer is for structural support and allows for contraction and relaxation during pulsatile flow within the artery, which aids in pumping the blood away from the heart to oxygenate all the organs and tissues. The artery 900 wall thickness is greater than the vein due to its function of regulating blood pressure throughout the circulatory system. Further, the interface between the tunica intima and media is where most of the diseased plaque resides, such as hardening of the artery due to calcification. Accordingly, the model described herein can replicate such diseased plaque as described below to allow for more accurate, challenge testing during device deployment.

The tunica adventitia (externia) is the supporting framework of the artery 900 functioning primary under high pressures. This component is composed primary of collagen and elastin fibers arranged lengthwise. It has a minimal percentage of adipose cells, blood vessels, elastic fibers, and nerves that adds to the anisotropic and non homogeneity. Accordingly, the model described herein replicates these tissues as described below to allow the modeled artery 900 to be pressurized up to, e.g., 300 mmHg gage that can be seen in an artery 900 for example when a patient coughs.

In order to create the synthetic artery, example embodiments provide for the modeling of the femoral artery using, e.g., computer software or other well know techniques. To get an appropriate architecture of the human common femoral artery (CFA) 900 and its bifurcation into the superficial 902 and deep arteries 903, images from the visible human project can be used. The computerized artery can then be transformed using well known mechanisms into a wax core mold used to produce the final wax core 915 shown in FIG. 9B, which will be used to maintain a constant inner diameter while the layers of the synthetic artery are made. A separate outer diameter wax core can also be constructed in a similar manner and will be used in other processing embodiments described below.

Next, one or more (usually three) partially cured pieces of PVA tubing can be created using mechanisms described above to produce the inner lining of the CFA. For example, a standard mold 330 in FIG. 3B with mandrels (e.g., stainless steel) of various size diameters (e.g., 7, 6, and 5 mm) can be used to create PVA tubes of approximately 0.5 mm thickness. The PVA can be created using mass chemicals of the following: 80 g DMSO; 20 g distilled water; and 14.5 g PVA. As is known, PVA is a granular component that can be mixed with the organic solvent DMSO (dimethylsulfoxide) and water to form a hydrogel an amorphous polymer containing high water content, where the polymeric chains are slightly or moderately cross linked and swollen in water up to thermodynamic equilibrium. The DMSO enables the polymer to be translucent. The mixture can then be heated using for example a hot plate with a stirrer.

Once the PVA is hot and viscous, it can then be injected to, e.g., a 0.5 mm thickness similar to the thickness of the intima and media tunica. More specifically, it can be injected into one end of the standard mold 330 until it flows out the other end. At least one freeze/thaw cycle should be performed in order to give the inner layer more strength and allow it to be formed around the wax core—i.e., provide partially cured pieces of PVA.

Each piece of partially cured PVA tubing can then be placed on the inner diameter wax core 915. The mandrel diameter should be kept consistent with the wax core diameter, an example of the diameter of each branching artery is shown in FIG. 9B. Care should also be taken to ensure the tubing is connected (i.e., touching) at the bifurcation in order to form non-brittle connections similar to those described above. Once fully formed, this composition should also provide the model with the tunica intima's lubricity.

Note that there are alternatives to creating this inner layer. For example, there could be cavity mold of the same architecture as the wax core 915 but with an increase diameter by approximately 1 mm, wherein PVA can be directly injected around it. Accordingly, the joining and molding process described for producing the inner layer of the synthetic artery is used herein for illustrative purposes only and is not meant to limit or otherwise narrow embodiments described herein unless otherwise explicitly claimed.

Once the inner layer is formed, a cyanoacrylate adhesive (e.g., Loctite® 4011) can then be used in the model to resemble calcification within the artery. More specifically, a line of adhesive can be put on the PVA inner tubing at the bifurcation, arch, or other appropriate CFA locations. The adhesive should fracture like calcification within the artery 900. Further, the addition of an adhesive within the PVA itself can contribute to the tensile strength. Note, however, that similar to some textile materials, the adhesive typically will not bond to the PVA. In addition to the calcification, other lesions 245 or abnormalities can also be included in the artery as previously described.

Meshed nylon or other textile material can then be cut and placed around the tubing, which will simulate the strength of collagen fibers within the artery. The meshed materials could be flat pieces of textile, or could be tubular in nature. Further, there may be several textile sections that can be separated out and placed over the inner PVA layer of the mold or there may be just a single section. In either event, sections of the fabric may be bonded together using an adhesive; however, this process may not be necessary. As one can appreciate, such fabric or meshed textile materials add more structural support when pressurized and more durability. Further, the addition of textile material within the PVA leads to variation of the material properties. For example, it can increase the elastic modulus and the ultimate stress. It also allows for pressures up to 300 mmHg gage, which as mentioned above can be seen in an artery when, for example, a patient coughs. In addition, the textile material allows for not only more strength but can also to keep the adhesive from piercing the PVA.

Next, an outer lining of PVA can be formed around the inner layer and textile material. The outer layer of PVA is modeled to simulate the tunica externia, consisting of loose fibrous connective tissue and part of the tunica media, consisting of smooth muscle. Example embodiments provide for enlarging the core diameter of the vessel (e.g., by 4 mm) and producing a mold (e.g., acrylic) similar to the one shown in FIG. 9E. The partially processed PVA, adhesive, and textile material artery is registered or placed in the mold 920 and an outer layer of hot PVA is injected, e.g., with a syringe. Once injected into the mold the working artery is cryogeled for example using approximately four freeze/thaw cycles (e.g., two hours freeze, two hours thaw=total hours 16) within a chamber. The process of cryogeling strengthens the PVA by adding more cross linking between the polymer chains. Once cured, the artery can be removed from the model and final touches can be made on any places that did not get fully filled with PVA (e.g., due to trapped air pockets, etc.). This may be accomplished by applying hot PVA on to the area of interest and curing it (e.g., freezing it with a mixture of dry ice and Isopropanol).

The inner diameter wax core 915 can then be broken out, e.g., by starting at the bifurcation and then pulling out the wax from each section. Once the wax core 915 is broken out of the artery, the artery should be placed in water to extract the DMSO allowing the mold to be handled without wearing gloves. Further, when placed in water the synthetic artery will not bond with surrounding PVA thus allowing it to be a replaceable component in the working model. Note that the PVA may have a shrink factor when inserted in water by approximately 10% (or about 0.02 inches of PVA). Accordingly, other embodiments contemplate adjusting the molds and models used to compensate for such shrinkage.

The subcutaneous tissue 906 simulated in FIG. 9D includes adipose tissue or fat and connective tissue that houses blood vessels and nerves. This layer acts as insulation and is important for regulating temperature within the body and storage of nutrients. The size of this layer varies throughout the body and from person to person. Further, the subcutaneous tissue 906 lies beneath the dermis and epidermis and is connected by bundles of elastic fibers.

In order to model this subcutaneous tissue 906, example embodiments provide for a mixture of dimethyl sulfoxide (DSMO) and a polyvinyl acetate-based glue (e.g., Elmer's® Glue), which is then added into PVA solution. For example, a mixture of glue and water with a 1:1 ratio can added to PVA (manufactured, e.g., using 80 g DSMO, 20 g DI water, and 10 g PVA) to make the material more elastic and simulate subcutaneous tissue 906. Note the synthetic subcutaneous tissue 906 will typically include 50% PVA (10 g) with a mixture of 25% DI water and 25% glue. Nevertheless, by changing the amount of PVA and base material (i.e., glue and DI water) the following trends can occur: increase in PVA grams increases the elastic modulus causing a more stiffer material; increasing the amount of glue is similar to an increase in PVA but may have averse affects; and an increase of glue to DI water may not allow for the polyvinyl acetate, that is within glue, to polymerize well and therefore leaches out the glue into water.

In another embodiment, other materials may be added to the above PVA mixture to simulate fibrous constituents within the body. For example, cotton or other type of material may be added to the base material, which may change the ratios of materials above. Accordingly, the above ratios and/or percentages of ingredients are used for illustrative purposes and are not meant to limit or otherwise narrow embodiments described herein unless otherwise explicitly claimed.

As noted above, there is muscle 910 between the bone 908 and artery 925, where the CFA lies above the pectineus and adductor longus muscles. The average thickness from the femoral head to the CFA is approximately 14.5 mm assuming the femoral head has a diameter of 50 mm. Therefore the thickness of the muscle 910 should be approximately 19 mm and as described below will consist manly of PVA (approximately 14 grams).

The representation of the bone 908 in the CFA model can be any number of well known materials. For example, the bone may be made of plastic, glass, stainless steel, or any other hardened material. Further, screws 912 or other adjustable mechanisms may be placed in into the bone (or the mold) to allow for distance variability from the artery, shown in FIG. 9D and described in greater detail below.

The synthetic subcutaneous tissue 906 is mixed together and filled in the mold 905 (e.g., the box shown in FIG. 9C) with the outer enlarged wax core made above, muscle 910 (PVA), and bone 908. Once all the components are in place, the a freeze/thaw cycle can be performed to cryogel the model and once done are placed in water to extract the DSMO. The following provides a more detailed description of how subcutaneous tissue 906, core mold, muscle 910, and bone 908 are combined. Although reference is made to a particular process and ordering of steps, one will recognize that there may be other mechanisms and ordering of steps to achieve similar results. Accordingly, the following description is used for illustrative purposes only and is not meant to limit or otherwise narrow the scope of embodiments herein described.

To begin the combining of tissue 906, muscle 910, and bone 908 that will be formed around the outer diameter wax core of the artery, a mold 905 (e.g., the box shown in FIG. 9C) is obtained and the large or outer core wax artery 925 made prior in set up is inserted therein. The bone 908 is then placed under the wax artery 925 so the orientation of the femoral head of the bone 908 is under the arc of the wax artery 925. The head of the femoral bone 908 should be approximately 15 mm vertical of the artery 925 as shown in FIG. 9D. Note, however, that the desired distance can be adjusted using the knobs 912 or screws under the bone 908. Once the bone 908 structure and the enlarged wax core 925 (diameters: approximately 11 mm, 10 mm, and 9 mm) are positioned in the surrounding mold 905, approximately 14 g of PVA can be poured into the mold. The PVA should be pored until the bone 908 is submerged and the PVA is touching the bottom portion of the arced waxed artery 925 (above the head of the femur bone). This represents the muscle 910 layer. The PVA should then be at least partially cured, for example by place dry ice around the mold 905 until the PVA hardens.

Note that although this process may be done manually, other embodiments allow for the automation of this process. In addition, although a box is shown as the mold 905, other structures are contemplated herein. For example, other embodiments consider a mold 905 that will follow the curvature of the artery 925, where the synthetic muscle encompasses the bone (e.g., the bottom half of the CFA and SFA, and all of the PFA and the subcutaneous tissue can be the top half).

Next, mold release can be sprayed or applied to the top surface of the PVA. The subcutaneous tissue 906 that was explained above in the set-up can then be poured in the mold until it is approximately 3 inches above the clear layer of PVA. Note that the amount of subcutaneous tissue 906 can vary due to the tester's discretion. As explained above, the subcutaneous layer 906 is a chemical make-up of usually a 1:1 ratio of glue and water mixture that is then mixed with a 1:1 ratio to PVA. Note that by varying the PVA gram composition increases the mechanical strength of the material, in which PVA is varied from approximately 10 g to 14 g and is approximately doubled in force and elastic modulus.

Next, the mold should be placed into a plastic or other similar container (e.g., a plastic bag) and then additional processing to fully cure the PVA, for example by placing the mold into a chamber for approximately 4 cycles of freezing and thawing (approximately 4 hours per cycle). Note that the mold may cycle over night so it will be ready in the morning. Then the mold should be taken out of the chamber and plastic container.

The mold can then be placed in DI H₂O in order to allow the DSMO to come out of the model. The model can be rinsed frequently and several times with water (e.g., every 2-3 hours 3 times). Note that an option to quicken this process may be to hook up a pump (e.g., a charcoal pump) or other device that will circulate the water. Once all the DSMO is out of the model, it can be handled without gloves. Next, the top layer (i.e., subcutaneous tissue 906) can be taken off and the artery outer diameter wax core 925 taken out (note that the wax core may be broken to get it out of the model). The wax core 925 can then be replaced with the artery model 925 made as stated above. The top (i.e., the subcutaneous tissue 906) can then be placed back on and the model is ready for testing (e.g., by hooking up a pump to the ends of the artery, which will pressurize the vessel at a normal pressure of 120 mmHg or else stated).

The above example embodiment provides a synthetic model designed to support routine quality testing and product development for vessel closure devices manufactured by various companies. The model is a good fit for testing medical devices in that it matches the elastic modulus of real tissue to a synthetic material without displaying non-homogeneous and anisotropic features. Further, it maintains the structure of the common femoral artery and the connection between the three components, the subcutaneous and muscular tissue in addition to the femur and pelvic bones. The model reproduces the elastic modulus of the artery and the subcutaneous tissue. The synthetic artery is also able to maintain a gage pressure of approximately 300 mmHg and simulates the lubricity of the intimal surface of the artery.

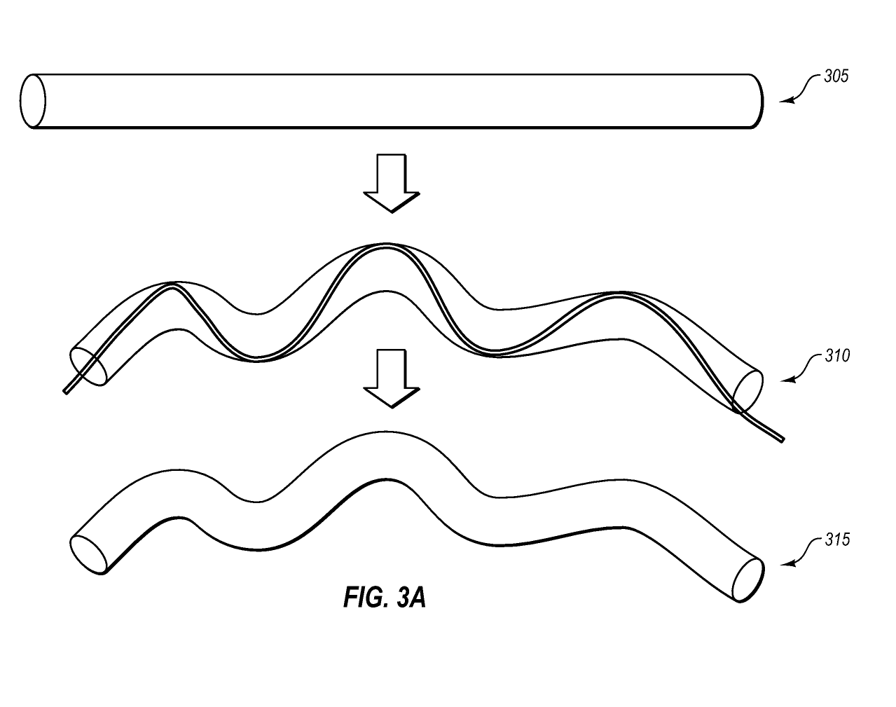

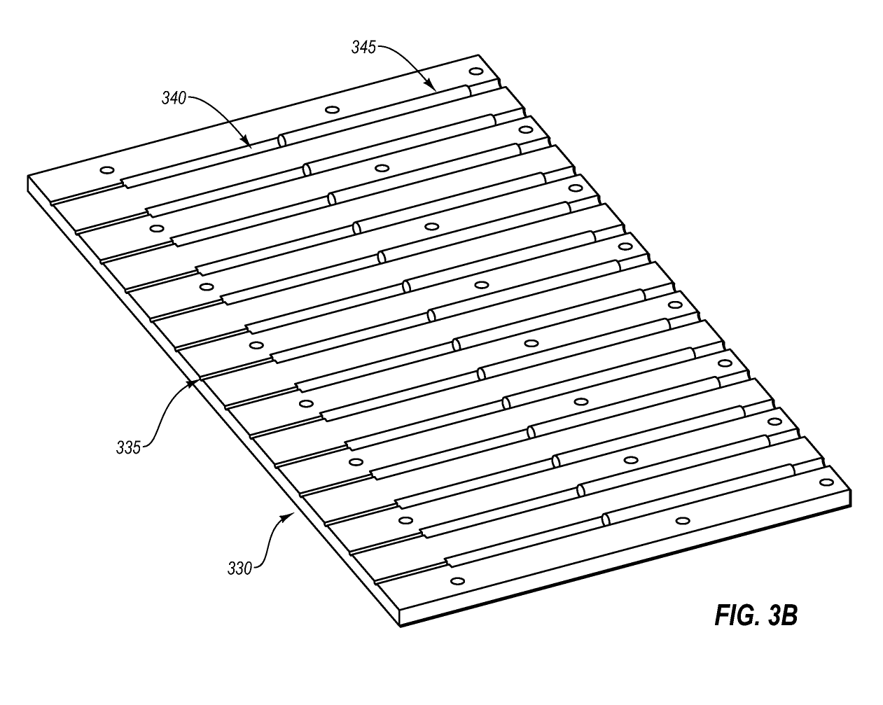

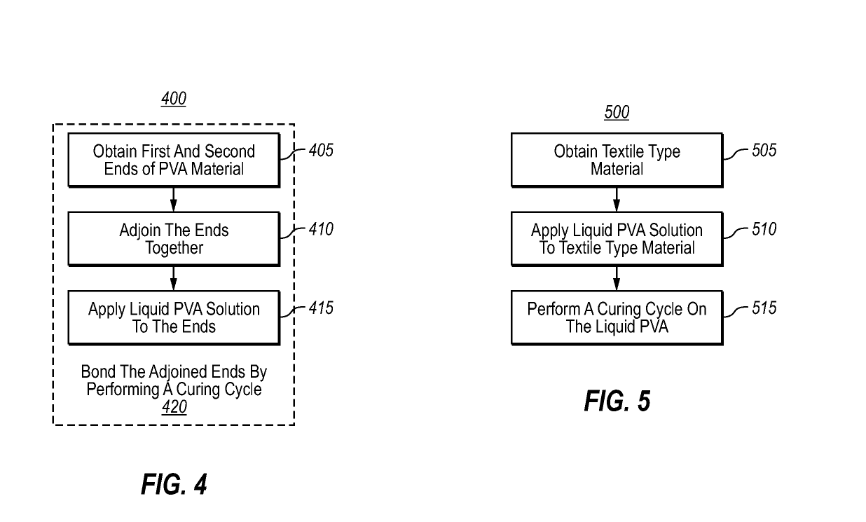

The present invention may also be described in terms of methods comprising steps and/or acts. The flow diagrams shown in FIGS. 4-8 illustrate steps and/or acts that may be performed in practicing various exemplary embodiments of the present invention. The following description of FIGS. 4-8 will occasionally refer to corresponding elements from FIGS. 1A-3B. Although reference may be made to a specific element from these Figures, such references are used for illustrative purposes only and are not meant to limit or otherwise narrow the scope of the described embodiments unless explicitly claimed. Also, the following description of the methods can be performed in differing orders and/or using different acts/steps.

FIG. 4 illustrates a method 400 of joining pieces of PVA in order to constructively form simulated complex anatomical models that can be used for demonstrating, testing, and/or developing medical functions and/or devices. Method 400 includes an act of obtaining 405 first and second ends of PVA material. For example, the first or second ends obtained may be of pre-made structures 105, 110, 130, 140, 145. In such case, the first and second ends of PVA may belong to two different pieces of material that are used to create a more complex structure for modeling anatomies. Alternatively, the ends 160, 170 may be from a single piece of PVA material 155. In such case, the ends 160, 170 may be from a two dimensional piece of PVA (e.g., flat PVA 160), which can then be used to produce a three dimensional model (e.g., tube 175). The ends or pieces of PVA material are at least partially cured and used in simulating a model intended to replicate specific anatomies present in human or mammalian vessels and/or tissues.

Method 400 also includes an act of adjoining 410 the ends together. This adjoining may mean that the ends are either touching or in close proximity to each other. Next, method 400 includes an act of applying 415 liquid PVA solution to the ends. Method 400 then includes a step for bonding 420 the adjoined ends by performing a curing cycle. Such curing cycle provides a cross linking between the liquid PVA solution and the adjoined first and second ends to form a typically tight, non-brittle connection. Also, the piece(s) of PVA material may, and typically are, only partially cured prior to the bonding stage and the one or more curing cycles solidifies the liquid PVA solution. Further, the curing cycle can be a freeze-thaw cycle performed manually or mechanically using an environmental chamber, pressure chamber, or both, along with a slurry of dry ice, alcohol, or both. In addition, the freeze-thaw cycle may vary between 20 and 200° C.

FIG. 5 illustrates a method 500 of creating an anatomical model with increased radial strength. In this embodiment, method 500 includes an act of obtaining 505 a textile type material. The textile type material should be sufficiently porous to allow viscous liquids to at least partially flow therein. The textile type material may be made from one or more sources of animals, plants, minerals, and synthetics. For example, the fibers of the textile type material may be made from cotton, silk, felt, satin, velvet, hetian, poly cotton, wool, hair, grass, rush, hemp, thistle, straw, bamboo, trees, basalt, glass, metal, polyester, aramid, acrylic, nylon, spandex, olefin, lurex, ingeo, or any other similar material.

Method 500 also includes an act of applying 510 liquid PVA solution to the textile type material. The applying process may be in the form of injecting PVA solution into a mold and allowing the PVA to flow within the textile material. Alternatively, or in conjunction, PVA solution may be applied on an outer surface and allowed to flow within the textile type material.

Finally method 500 includes an act of performing 515 a curing cycle on the liquid PVA. By performing one or more curing cycles the liquid PVA solidifies to the textile type material and is formed to provide a model intended to replicate the specific anatomies present in a human and/or mammal. By providing the textile type material within the PVA, the radial strength of the model can be increased over just the PVA solution alone and provides a PVA vessel model that can withstand fluid and other pressures.

As previously mentioned, the textile type material may be placed within the mold itself and the liquid PVA solution injected therein. Alternatively, the textile type material may be applied to a partially cured piece of PVA through the bonding process similar to the attachment of two pieces of PVA as previously described.

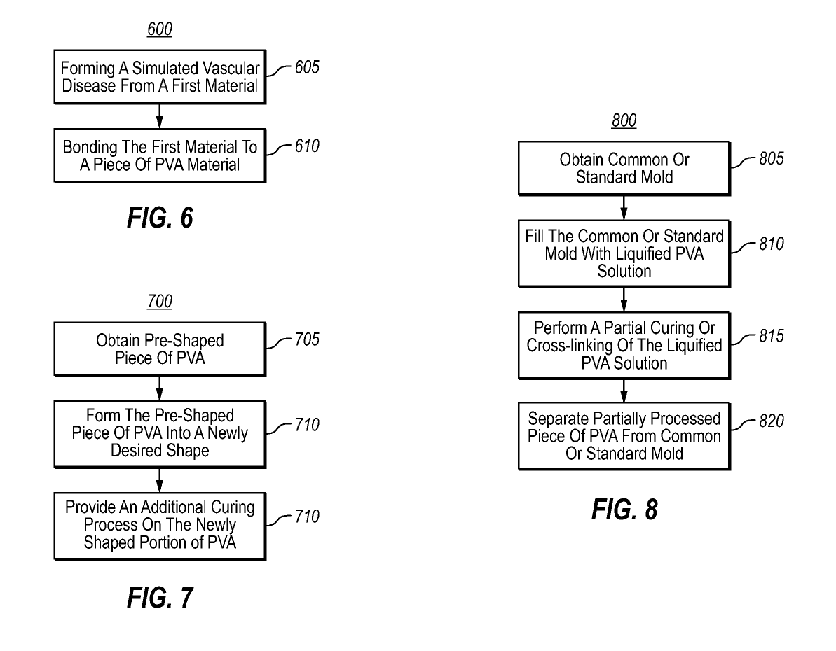

FIG. 6 illustrates a method 600 of creating anatomical models with simulated plaque, lesions, chronic total occlusions, as well as other vascular diseases for more accurately replicating such abnormalities within the anatomical model—as opposed to just using a single vessel material in a one time molding process. Method 600 includes an act of forming 605 a simulated vascular disease from a first material. Note that this first material may be a different material than PVA. Also the first material may include any one of a polyvinyl acetate-based glue, PVA solution, sodium borate, a polymer, fiber, fabric, cyanoacrylate adhesive, distilled water, or the like. The simulated vascular disease 215 may also replicate any one of a fatty plaque, chronic total occlusion, restenosis, fibrous plaque, friable plaque, or calcified lesion.

Method 600 also includes an act of bonding 610 the first material to a piece of PVA material. The bonding of the material can be performed in a separate process from forming the simulated vascular disease. Further, the bonding may further include an act of creating a void 232 in a portion of a core 220 of a mold 210 used for creating the specific anatomical structure, wherein the outer diameter 240 of the core 220 can produce an offset from the outer diameter 245 of the mold 210 and can be used to form the inner lining of the anatomical structure. The material may then be placed within the void 232 and the PVA filled within the mold 210. The PVA material can be initially a liquid solution, which is then at least partially cured to bond the simulated vascular disease 215 within the specific anatomical structure.

The bonding may be performed by coating the material for the simulated vascular disease 215 with liquid PVA solution. The PVA coated simulated coated vascular disease 215 can then be placed into the void 232 of a core 220 and sealing the mold 210 around the core 220 and the void 232. The PVA material may then be injected into the mold 210, which fills the space created between the outer diameter 245 of the mold 210 and the offset 240 of the core 220. The PVA material may then be partially cured in order to create a cross-linking between the PVA material and the PVA coating on the vascular disease 215; thus ensuring that the simulated vascular disease does not flow downstream in the mold as the PVA material is injected into the mold.

In an alternative embodiment, the bonding mechanism can be achieved by coating the simulated vascular disease 215 with PVA solution. The PVA coated simulated vascular disease 215 can then be placed onto a partially processed piece of PVA material, which can be preformed into the specific anatomical structure. Finally, a curing process can be performed on the PVA coated vascular disease 215 and the PVA material in order to produce a cross-linking therewith; thus ensuring the simulated vascular disease material 215 has a flexible, non-brittle connection with the specific anatomical structure.

FIG. 7 illustrates a flow diagram of a method 700 of creating multiple different anatomical models for demonstrating or testing medical devices and/or procedures by forming a partially processed, pre-shaped piece of PVA into a desired specific shape. Method 700 includes an act for obtaining 705 a pre-shaped piece of PVA. The pre-shaped piece of PVA can be partially cured or cross-linked such that at least at portion of the pre-shaped piece of PVA can be modifiable. The shape of the partially cured PVA may be chosen from flat like structure, substantially straight tube like structure, cone like structure, or spherical like structure; however, more complex shapes such as specific anatomies are also contemplated herein.

Next method 700 includes an act of forming 710 the pre-shaped piece of PVA into a newly desired shape. The newly desired shape can be intended to replicate the specific anatomy present in human and/or mammalian vessels and/or tissues. Also note that the shaped piece of PVA may be formed into the newly desired shape using a malleable object such as a rod, tube, shaft, wire, or other thin straight piece of metal. Also, the malleable object may be coated with a flexible polymer or other material to prevent collapsing or kinking of the pre-shaped piece of PVA when using the malleable object. In one embodiment, malleable object can be formed on the inner portion of the pre-shaped PVA prior to the curing or cross-linking. In an alternative embodiment, the pre-shaped piece of PVA may be formed into the newly desired shaped using external constraints. Also note that the newly desired shape may be used to represent a tubular organ and the lumen thereof can be held unobstructed with one or more of a rod, mandrel, or wax core. In an alternative embodiment, the pre-shaped piece of PVA replicates an anatomy in a first human or mammal patient and the newly desired shape replicates an anatomy of a second human or mammalian patient.

Method 700 also includes a step for providing 715 an additional curing process on the newly shaped portion of PVA. In other words, by providing additional curing, the pre-shaped portion of PVA is caused to substantially maintain the newly desired shape intended to replicate a specific anatomy. For example, as shown in FIG. 3A, the general shaped tubing 305 can be formed using malleable object wire as shown in 310. The curing process then allows the general shaped piece of PVA to maintain the desired form as shown in 315.

FIG. 8 illustrates a flow diagram of a method 800 of manufacturing pieces of PVA using a common or standard mold, wherein each of the pieces of PVA can later be formed into multiple different anatomical models. Method 800 includes an act for obtaining 800 a common or standard mold used to produce a plurality of general shaped piece of PVA. For example, FIG. 3B illustrates the base plate 330 of a mold used to produce straight tubular pieces of PVA. Method 800 then includes a step for filling 810 the common or standard mold with liquid PVA solution. Method 800 then includes an act of performing 815 a partial curing or cross-linking of the liquid PVA solution. This partial curing or cross-linking of the liquid PVA solution allows at least a portion of the piece of PVA to still be modifiable.

Finally, method 800 includes an act of separating 820 the partially processed piece of PVA from the common or standard mold. This produces a partially processed, preformed, generally shaped piece of PVA than can later be formed into one or multiple different desired shapes intended to replicate specific anatomies present in human and/or mammalian vessels and/or tissues. The curing process may be four or less freeze-thaw cycles. Also the general shaped piece of PVA made may be manufactured with a plurality of general shaped pieces of PVA within a single mold. For example, they may be formed using molds described in FIG. 3B. Further, the general shaped piece of PVA may be tested for accuracy and/or consistency. Such testing may use a computer program product with executable instructions stored on a medium. Also the core of the standard or common mold may be steel and/or wax.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A method of joining pieces of poly(vinyl alcohol) PVA in order to constructively form simulated models, the method comprising:
obtaining first and second ends of one or more pieces of PVA material, which have been at least partially cured;
adjoining at least a portion of the first and second ends of the one or more pieces of PVA material;
applying a liquid PVA solution to at least the adjoined portions of the first and second ends; and
bonding the adjoined portions of first and second ends together by performing one or more curing cycles on the liquid PVA solution, which provides a cross-linking between the liquid PVA solution and the adjoined first and second ends to form a non-brittle connection.

2. The method of claim 1, wherein the first and second ends are part of a same piece of PVA material.

3. The method of claim 2, wherein the PVA material is a two dimensional piece of PVA, and the bonding produces a three dimensional model.

4. The method of claim 1, wherein the first and second ends of PVA belong to two different pieces of PVA material and the bonding creates a more complex structure for modeling anatomies.

5. The method of claim 1, wherein the at least a portion of the first and second ends are touching during the curing cycle by a mold.

6. The method of claim 1, wherein the curing cycle is a freeze-thaw cycle performed manually or mechanically using one or more of an environmental chamber, pressure chamber, or both along with a slurry of dry ice, alcohol, or both.

7. The method of claim 6, wherein the freeze-thaw cycle varies between 20 and 200 degrees Celsius.

8. The method of claim 1, wherein the one or more pieces of PVA material are only partially cured prior to the bonding stage, and wherein the one or more curing cycles further solidifies the one or more pieces of PVA material.

9. A method of creating an anatomical model with increased radial strength to represent muscle or other tissues, the method comprising:
obtaining a piece of textile type material sufficiently porous to allow viscous liquids to at least partially flow therein;
applying a liquid PVA solution to the textile type material such that the PVA solution flows therein; and
performing one or more curing cycles on the liquid PVA solution in order to solidify the liquid PVA solution to the textile type material, which is formed to provide a model intended to replicate specific anatomies.

10. The method of claim 9, wherein the textile type material is made from one or more sources of animals, plants, mineral, and synthetics.

11. The method of claim 10, wherein fibers of the textile type material are made from one or more of cotton, silk, felt, satin, velvet, hessian, polycotton, wool, hair, grass, rush, hemp, sisal, straw, bamboo, trees, basalt, glass, metal, polyester, aramid, acrylic, nylon, spandex, olefin, lurex, or ingeo.

12. The method of claim 9, wherein the method further comprises:
placing the textile type material into a mold used for forming anatomical models of human, mammalian, or both, type tissues, arteries, or both; and
injecting the liquid PVA solution into the mold in order to allow the liquid PVA solution to flow into at least a portion of the textile type material.

13. The method of claim 9, wherein the method further comprises:
prior to applying the liquid PVA solution into the textile type material, adjoining the textile type material to a partially cured piece of PVA, wherein upon applying the liquid PVA solution, at least a portion of the liquid PVA flows through the textile type material and comes in contact with the partially cured piece of PVA; and
bonding the PVA solution to the partially cured piece of PVA by performing the one or more curing cycles, which provides a cross-linking between the contact of the partially cured piece of PVA and the liquid PVA solution.

14. An anatomical model with increased radial strength to represent muscle or other similar tissues by combining a fabric type material with poly(vinyl alcohol) PVA, which can be molded to form the anatomical model used for demonstrating, developing, or testing medical functions and/or devices, the method comprising:
a piece of PVA material that is at least partially cured; and
a textile type material that is sufficiently porous to allow at least a portion of a liquid PVA solution to flow therein that makes up at least a portion of the piece of partially cured PVA, the liquid PVA solution solidified within the textile type material and formed to provide a model intended to replicate specific anatomies with radial strength greater than just the solidified PVA solution alone.

15. The anatomical model of claim 14, wherein the textile type material is made from one or more sources of animals, plants, mineral, and synthetics.

16. The anatomical model of claim 15, wherein fibers of the textile type material are made from one or more of cotton, silk, felt, satin, velvet, hessian, polycotton, wool, hair, grass, rush, hemp, sisal, straw, bamboo, trees, basalt, glass, metal, polyester, aramid, acrylic, nylon, spandex, olefin, lurex, or ingeo.

17. The anatomical model of claim 14, wherein the model is formed by:
placing the textile type material into a mold used for forming anatomical models of human, mammalian, or both, type tissues, arteries, or both; and
injecting the liquid PVA solution into the mold in order to allow the liquid PVA solution to flow into at least a portion of the textile type material.

18. The anatomical model of claim 14, wherein the model is formed by:
adjoining the textile type material to a partially cured piece of PVA;
applying the liquid PVA solution to the textile type material such that at least a portion of the liquid PVA flows through the textile type material and comes in contact with the partially cured piece of PVA; and
bonding the PVA solution to the partially cured piece of PVA by performing the one or more curing cycles, which provides a crosslink between the contact of the partially cured piece of PVA and the liquid PVA solution.
